(19) United States
(12) Patent Application Publication
(10) Pub. No.: US 2007/0273775 A1
(43) Pub. Date: Nov. 29, 2007

(54) Image sensor with built-in thermometer for global black level calibration and temperature-dependent color correction

(76) Inventor: Jutao Jiang, Boise, ID (US)

Correspondence Address: DICKSTEIN SHAPIRO LLP, 1825 EYE STREET, NW, WASHINGTON, DC, 20006, US

(21) Appl. No.: 11/439,179

(22) Filed: May 24, 2006

(51) Int. Cl. H04N 9/64

(52) U.S. Cl. 348/244

(57) ABSTRACT

A semiconductor image sensor is provided that includes an on-chip temperature-sensitive element. The signal output of the temperature-sensitive element is used to determine a black level value for the image sensor and to calculate a color correction value to be applied to the signal output of the semiconductor image sensor. The signal output of the temperature-sensitive element may be determined by time-averaging a series of signal outputs from the temperature-sensitive element. The temperature-sensitive element signal output may also be determined by combining, e.g., averaging, the signal outputs of a plurality of on-chip temperature-sensitive elements.

### FIELD OF THE INVENTION

The invention relates generally to semiconductor imagers. More specifically, the invention relates to black level calibration and temperature-dependent color correction in semiconductor imagers.

### BACKGROUND OF THE INVENTION

Complementary metal-oxide semiconductor (CMOS) image sensors utilize sensor arrays that are composed of rows and columns of pixels. The pixels are sensitive to light of various wavelengths. When a pixel is subjected to a wavelength of light to which the pixel is sensitive, the pixel generates electrical charge that represents the intensity of the sensed light. When each pixel in the sensor array outputs electrical charge based on the light sensed by the array, the combined electrical charges represent the image projected upon the array. Thus, CMOS image sensors are capable of translating an image of light into electrical signals that may be used, for example, to create digital images.

Ideally, the digital images created by CMOS image sensors are exact duplications of the light image projected upon the sensor arrays. However, various noise sources can affect individual pixel outputs and thus distort the resulting digital image. Some noise sources may affect the entire sensor array, thereby requiring frame-wide correction of the pixel output from the array. One such corrective measure applied to the output of the entire sensor array is the setting of a base-line black level (described below). Other noise sources may only affect specific portions of the sensor array. For example, row-specific noise may be generated from a mismatch of circuit structures in the image sensors due to variations in manufacturing processes. The effect of row-specific noise in an image sensor is that rows or groups of rows may exhibit relatively different outputs in response to uniform input light.

A common method for setting a corrective black level and removing the effects of row-specific noise is to use dark rows and dark columns in an image sensor, as demonstrated in FIG. 1. FIG. 1 shows an image sensor 100 that includes a pixel array 140 organized into columns and rows. The pixel array 140 contains an active area 142, dark rows 144 and dark columns 146. Although not shown in FIG. 1, dark rows 144 may also be located above the active area 142, and dark columns 146 may also be located to the left of the active area 142. Each pixel in the active area 142 is configured to receive incident photons and to convert the incident photons into electrical signals. The pixels in the dark rows 144 and dark columns 146 are ideally designed to output signals corresponding to no light or black images. Signals from the pixel array 140 are output row-by-row as activated by a row driver 145 in response to a row address decoder 155. Column driver 160 and column address decoder 170 are also used to selectively activate individual pixel columns. A timing and control circuit 150 controls address decoders 155, 170 for selecting the appropriate row and columns for pixel readout. The control circuit 150 also controls the row and column driver circuitry 145, 160 such that driving voltages may be applied. Each pixel generally outputs both a pixel reset signal Vᵣₛₜ and a pixel image signal V_{sig}, which are read by a sample and hold circuit 161. Vᵣₛₜ represents a reset state of a pixel cell. V_{sig} represents the amount of charge generated by the photosensor in a pixel cell in response to applied light during an integration period. The difference between V_{sig} and Vᵣₛₜ represents the actual pixel cell output with common-mode noise eliminated. The differential signal (Vᵣₛₜ−V_{sig}) is produced by differential amplifier 162 for each readout pixel cell. The differential signals are then digitized by an analog-to-digital converter 175. The analog-to-digital converter 175 supplies the digitized pixel signals to an image processor 180, which forms and outputs a digital image.

Dark columns 146 and dark rows 144 are areas within the pixel array 140 that do not receive light or capture image data. Pixel outputs from the dark rows 144 and dark columns 146 are used to both set the black level for the entire pixel array 140 and correct row-specific noise.

Pixels in the dark columns 146 and dark rows 144 are typically covered with a metal plate. Pixels blocked from sensing light via a metal plate are referred to as optically black pixels. Because, theoretically, no light is sensed by the optically black pixels, the only charge generated by the optically black pixels is internal noise-induced charge. This is often referred to as dark current. Dark current is temperature dependent, meaning that the level of internal noise-induced charge is related to the temperature of the optically black pixel. One method of compensating for this temperature-dependent noise is through the calculation of average optically black pixel output values, which represent average noise values, and then subtracting these average values from the outputs of the pixels in the active area 142. For example, an appropriate black level may be set by calculating an average optically black pixel output for the optically black pixels in the dark rows 144, and then subtracting this average value from the output of every pixel in the active area 142 and dark columns 146. Row-specific noise in pixel array 140 may also be compensated for by calculating an average optically black pixel output for each row of optically black pixels in the dark columns 146. The calculated optically black pixel average for each row is then subtracted from the values of the active pixels in the corresponding row.

A drawback with using optically black pixels in calculating a black level value is that optically black pixels are sensitive to more than just background or internal noise. Optically black pixels may generate charge in response to random, localized noise sources, thus artificially altering the calculated black level. For example, optically black pixels may generate excess charge as a result of pixel blooming. Blooming is caused when too much light enters a pixel, thus saturating the pixel. A pixel subject to blooming is unable to hold all of the charge generated as a result of sensed light. Consequently, any excess charge may leak from the pixel and contaminate adjacent pixels. Optically black pixels that generate excess charge as a result of the blooming of neighboring pixels in the active area 142 will result in an artificially high black level. Infrared (IR) reflections may also result in excess charge generation. IR reflections occur when IR radiation is incident on pixels within the pixel array 140 and is trapped within the image sensor 100. The IR radiation, which also causes pixels to generate charge, may repeatedly reflect against multiple optically black pixels, thus again artificially inflating the amount of generated charge. In these cases, the black level sensed by the optically black pixels is generally higher than the ideal black level because of the charge collected from these noise sources.

There is, therefore, a need and desire for a method and apparatus for efficiently generating and applying a stable black level value to the pixel outputs of a solid state imager such as, for example, a CMOS imager.

### BRIEF DESCRIPTION OF THE DRAWINGS

The invention will be more readily understood from the following detailed description of the invention which is provided in connection with the accompanying drawings, in which:

FIG. 1 depicts a conventional image sensor;

FIG. 2 depicts an image sensor with an on-chip temperature-sensitive element in accordance with an example embodiment of the invention;

FIG. 3 is a schematic of an on-chip temperature-sensitive element in accordance with an example embodiment of the invention; and,

FIG. 4 depicts an imaging system in accordance with an example embodiment of the invention.

### DETAILED DESCRIPTION OF THE INVENTION

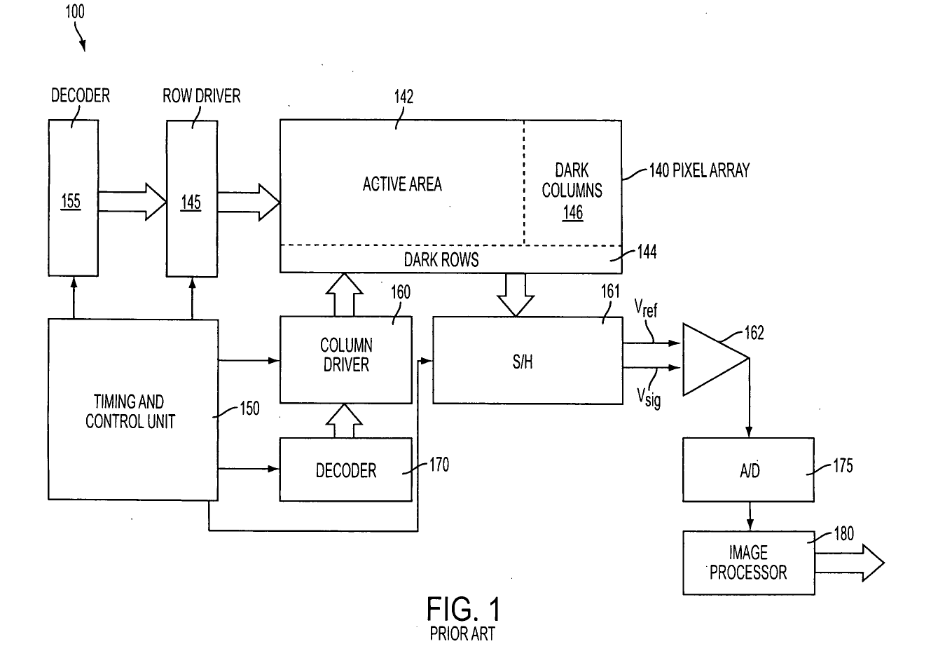

One method that has been used in response to the disadvantages of using optically black pixels to set the black level value, as explained above, has been to tie the photodiode of some or all pixels in the dark rows 144 (FIG. 1) to a fixed voltage, as presented in U.S. patent application Ser. No. 11/066,781. The fixed voltage is, in essence, a fixed black level for the pixel array 140. The advantages of this method is that the black level calculation is not influenced by blooming, IR reflections, etc., and that every frame utilizes a constant and unchanging black level. However, tied pixels are not sensitive to any changes in dark current due to temperature. Thus, a black level generated by utilizing tied pixels may not accurately compensate for the noise caused by temperature dependent dark current.

The noise generated by thermal-induced dark current can be calculated and compensated for by directly measuring the temperature of an image sensor. In an example embodiment of the invention, an on-chip thermometer or other temperature-sensitive element is used to directly measure the temperature of the image sensor; the measured temperature is then used to calculate the amount of thermal-induced dark current for which compensation is necessary.

The relationship between dark current I_{d} generated by a pixel and temperature T, in Kelvin, is shown below in Equation 1.

$${I}_{d} = {AT}^{3 / 2} {e}^{- \frac{{E}_{g}}{2 kT}} + {BT}^{3} {e}^{- \frac{{E}_{g}}{kT}} . \qquad Equation 1$$

In Equation 1, the exponential terms represent probabilities for electron/hole generation (i.e., the probability for exciting an electron from the top of a valence band to the bottom of a conductance band). A and B are coefficients whose values may be determined (as explained below). E_{g} represents the bandgap of silicon, typically 1.12 eV. The Boltzmann constant, k, is 8.617385×10⁻⁵ eV/K. Thus, if the temperature T is known, the dark current I_{d} can be calculated in units of electrons per second. With a known integration time for the image sensor, the dark charge (in electrons) can be calculated from the dark current. By using a known gain setting for the sensor and also a known electrons-to-bits conversion factor (in bits/electrons) for the sensor, a black level value (in bits) can be calculated for the pixels in the sensor.

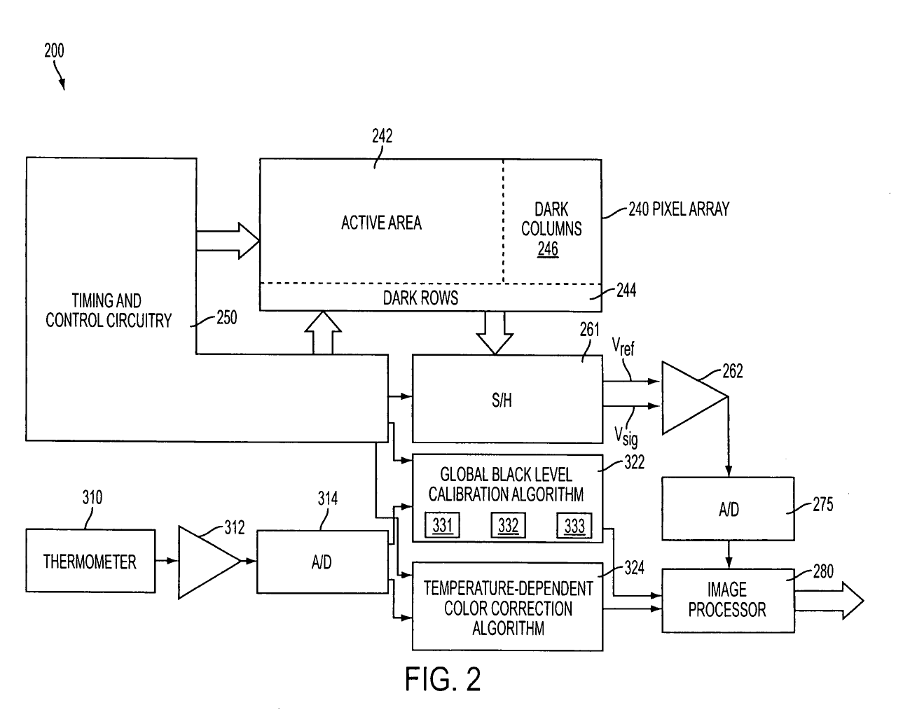

FIG. 2 show an image sensor 200 that includes an on-chip temperature sensitive element 310, according to an example embodiment of the invention. Like the image sensor 100 of FIG. 1, the image sensor 200 includes a pixel array 240 organized into columns and rows. The pixel array 240 contains an active area 242, dark rows 244 and dark columns 246. Although not shown in FIG. 2, dark rows 244 may also be located above the active area 242, and dark columns 246 may also be located to the left of the active area 242. As explained above, the dark rows 244 and dark columns 246 contain optically black pixels. The dark rows 244 and dark columns 246 may also contain a number of tied pixels (pixels tied to a fixed voltage, as explained above). The optically black pixels and tied pixels are used to reduce row-specific noise in the pixel array 240 and to calibrate the invention, as described below.

Signals from the pixels of pixel array 240 are output row-by-row as activated by timing and control circuitry 250, which includes a row driver, a column driver and address decoders, each controlled by a timing and control unit (as discussed in detail with respect to FIG. 1). Each pixel generally outputs both a pixel reset signal Vᵣₛₜ and a pixel image signal V_{sig}, which are read by a sample and hold circuit 261. The difference between V_{sig} and Vᵣₛₜ represents the actual pixel output with common-mode noise eliminated. The differential signal (Vᵣₛₜ−V_{sig}) is produced by differential amplifier 262 for each readout pixel cell. The differential signals are then digitized by an analog-to-digital converter 275. The analog-to-digital converter 275 supplies the digitized pixel signals to an image processor 280, which forms and outputs a digital image.

The temperature sensitive element 310 measures the temperature of the image sensor 200 and outputs a corresponding analog signal. The analog signal is amplified by amplifier 312 and then converted into a digital signal via analog-to-digital converter 314. The digital temperature signal is then used to calculate a global black level using Equation 1 (block 322) which is then applied to the digitized pixel signals by image processor 280. Sub-blocks 331, 332 and 333 represent specific calculations or conversions that occur in block 322, and will be described below in detail. The digital temperature signal may also be used to calculate other corrections or adjustments that may be applied by the image processor 280. For example, a global color correction algorithm may be applied (block 324) as a function of the digital temperature. Blocks 322, 324 may be logic or hardwired circuitry that are controlled by the timing and control circuitry 250.

The temperature sensitive element 310 is implemented as one or more on-chip temperature-sensitive elements located in the periphery circuit region of the image sensor 200. The temperature-sensitive element 310 may be placed far away from the optically active area 242 and may also be covered by metal layers or a black color filtering array (CFA) so as to minimize the effect of local temperature variations caused by strong incident light or blooming. Because silicon has good thermal conductivity, the temperature difference between the optically active area 242 and the location of the temperature-sensitive element 310 is negligible. To increase the temperature measurement accuracy, the output of the temperature-sensitive element 310 can be averaged over a specific number of image frames. In addition, more than one temperature-sensitive element 310 may be implemented around the image sensor, wherein the output signals of each temperature-sensitive element 310 are averaged to determine a single temperature-sensitive element signal output for the image sensor.

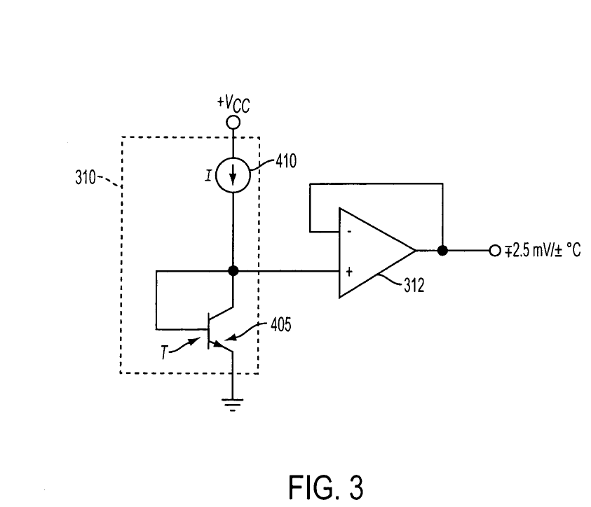

The temperature-sensitive element 310 can be a diode-connected bipolar transistor. An example of a temperature-sensitive element is depicted in FIG. 3, which represents both temperature-sensitive element 310 and amplifier 312. The temperature-sensitive element 310 is represented by a diode-connected bipolar transistor 405 whose output under a constant current source 410 is directly proportional to its temperature. The output from transistor 405 is amplified by amplifier 312 so as to vary, for example, 2.5 mV for every degree of temperature change of the transistor 405.

Before the temperature-sensitive element 310 may be used reliably, the temperature-sensitive element 310 must be calibrated. Calibration occurs after manufacturing of the image sensor and during a testing phase. The temperature-sensitive element 310 can be calibrated with just one or two known temperature points. For a diode-connected bipolar transistor thermometer, as depicted in FIG. 3, the relationship between the digital output of the thermometer and the actual temperature is linear, as shown below in Equation 2.

T=mS+b Equation 2.

Thus, if two known temperatures T and their corresponding digital outputs S are known, the slope m and y-intercept b may also be found. The calibration process may be simplified for a given temperature-sensitive element design and manufacturing process if the slope m is found to be constant or very nearly constant among multiple image sensors. In this case, only one known temperature T would be needed in order to calibrate the temperature-sensitive element output S using Equation 2.

In practice, the image sensor 200 is manufactured with an on-chip temperature-sensitive element 310 (of FIG. 3). During a probe test of the image sensor at a known temperature, the temperature-sensitive element output is calibrated using Equation 2. Thus, any given digital output from the temperature-sensitive element may be accurately translated into a corresponding temperature. Also during the probe test, and once the temperature calibration has occurred, coefficients A and B of Equation 1 are also determined. Coefficients A and B are determined by comparing the resultant black level set using either tied or optically black pixels with the results of a black level calculation using Equation 1. This comparison can occur during the probe test because temperature and other artifact-causing problems (such as blooming and IR radiation) can be tightly controlled during the probe test. By comparing the black level applied using the optically black or tied pixels in known conditions, coefficients A and B may be estimated using a best-fit determination.

After testing and calibration, the temperature-sensitive element 310 is ready to be used for determining black levels for the image sensor. While in use, the temperature-sensitive element output is sampled and a current temperature is found (block 331 of FIG. 2). Using the current temperature and Equation 1, the amount of temperature-induced dark current is calculated (block 332), and a corresponding corrective black level is then calculated (block 333) by converting the calculated induced dark current to a charge value and then converting the charge value to a corresponding black level value. The corrective black level is applied to all pixels in the frame for which the temperature was measured using image processor 280.

As an alternative to applying Equation 1 during each use of the image sensor, a look-up table could be generated during the post-manufacturing testing stage. In this embodiment, the temperature-sensitive element is calibrated as described above and then a look-up table is populated by using Equation 1 to calculate corrective black levels necessary for any given temperature within a range of temperatures. Then, during operation of the image sensor, no calculations need occur in determining a corrective black level. Instead, for each frame of the image sensor, a temperature output is measured and then a corresponding corrective black level is found by referencing the look-up table (in block 322).

Although a primary purpose of the on-chip temperature-sensitive element is to correct for temperature-generated dark current, the on-chip temperature-sensitive element may be used for other purposes. For example, the measured temperature may be used in a color correction algorithm 324 of FIG. 2. In one color correction scheme, it is recognized that pixel output is affected by electrical cross-talk between pixels. Electrical cross-talk is largely due to electron diffusion, which increases exponentially with temperature. Thus, a color correction scheme that corrects for electrical cross-talk can be temperature dependent. In addition, the pixel absorption of various wavelengths of energy, including various colors and infrared wavelengths, is also temperature dependent. This implies that in order to achieve the best possible imaging quality and color rendition at any given temperature, the imager sensor's temperature change should be included during all on-chip color calibrations or corrections.

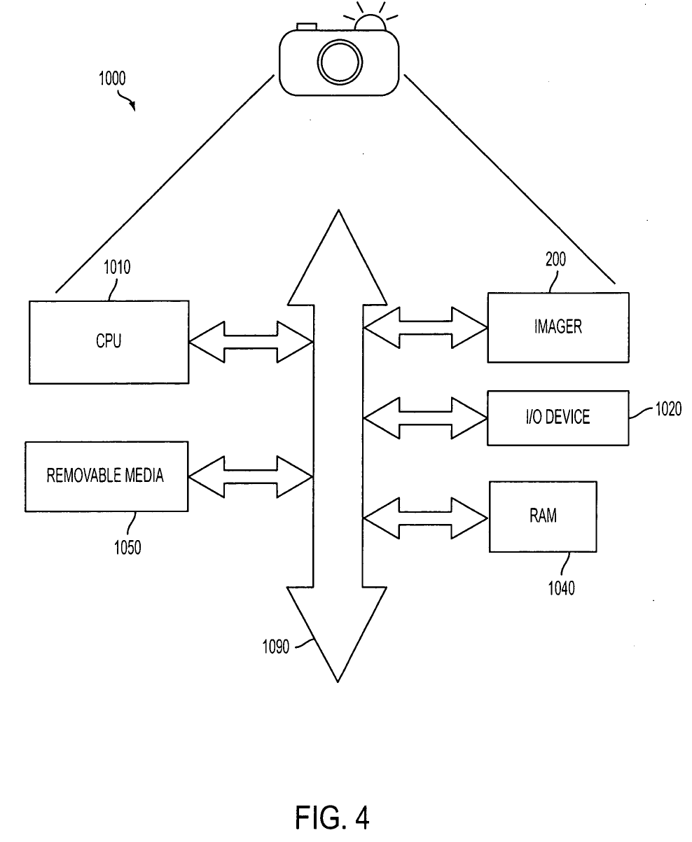

An image sensor with an on-chip temperature-sensitive element may be used in any system which may employ a digital imager, including, but not limited to a computer system, camera system, scanner, machine vision, vehicle navigation, video phone, surveillance system, auto focus system, star tracker system, motion detection system, image stabilization system, and other imaging systems. Example digital camera systems in which the invention may be used include both still and video digital cameras, cell-phone cameras, handheld personal digital assistant (PDA) cameras, and other types of cameras. FIG. 4 shows a typical processor system 1000 that includes an imaging device 200 (FIG. 2) and which includes a pixel array and on-chip temperature-sensitive element constructed in accordance with the invention. The processor system 1000 is an example of a system having digital circuits that could include image sensor devices. System 1000, for example a digital camera system, generally comprises a central processing unit (CPU) 1010, such as a microprocessor which controls camera function and may further perform image processing functions, that communicates with an input/output (I/O) device 1020 over a bus 1090. Imaging device 200 also communicates with the CPU 1010 over the bus 1090. The processor system 1000 also includes random access memory (RAM) 1040, and can include removable media 1050, such as flash memory, which also communicates with the CPU 1010 over the bus 1090. The imaging device 200 may be combined with a processor, such as a CPU, digital signal processor, or microprocessor, with or without memory storage on a single integrated circuit or on a different chip than the processor.

The processes and devices described above illustrate preferred methods and typical devices of many that could be used and produced. The above description and drawings illustrate embodiments, which achieve the objects, features, and advantages of the present invention. However, it is not intended that the present invention be strictly limited to the above-described and illustrated embodiments. Any modification, though presently unforeseeable, of the present invention that comes within the spirit and scope of the following claims should be considered part of the present invention.

What is claimed as new and desired to be protected by Letters Patent of the United States is:

1. A semiconductor image sensor, comprising:
at least one pixel;
a temperature-sensitive element configured to output a signal related to a sensed temperature of the image sensor; and
a black level setting unit configured to use the output signal of the temperature-sensitive element to calculate a black level to be applied to an output signal of the at least one pixel.

2. The semiconductor image sensor of claim 1, wherein the black level setting unit comprises:
a temperature-sensitive element output-to-temperature unit configured to convert the output signal of the temperature-sensitive element to a corresponding temperature;
a temperature-to-dark current unit configured to convert the temperature to a temperature-induced dark current value; and
a dark current-to-black level unit configured to convert the temperature-induced dark current value to the black level.

3. The semiconductor image sensor of claim 2, wherein the temperature-sensitive element output-to-temperature unit is configured to use a linear relationship between the output signal of the temperature-sensitive element and the corresponding temperature.

4. The semiconductor image sensor of claim 2, wherein the temperature-to-dark current unit is configured to calculate the dark current value by using a relationship between the dark current value and a probability for exciting an electron from a top of a valence band to a bottom of a conductance band.

5. The semiconductor image sensor of claim 2, wherein the dark current-to-black level unit is configured to convert the dark current value to a charge value, and to convert the charge value to the black level.

6. The semiconductor image sensor of claim 1, wherein the temperature-sensitive element comprises a plurality of temperature-sensitive elements whose signal outputs are combined for use by the black level setting unit.

7. The semiconductor image sensor of claim 6, wherein the signal outputs of the plurality of temperature sensitive elements are combined by an averaging process.

8. The semiconductor image sensor of claim 1, wherein the black level setting unit is configured to input a time-averaged signal output of the temperature-sensitive element.

9. The semiconductor image sensor of claim 1, further comprising a color correction unit configured to use the signal output of the temperature-sensitive element to calculate a color correction value to be applied to the signal output of the at least one pixel.

10. The semiconductor image sensor of claim 1, wherein the black level setting unit is further configured to use a lookup table to determine the black level that corresponds to the signal output of the temperature-sensitive element.

11. A method of operating a semiconductor image sensor, comprising:
measuring a temperature of the semiconductor image sensor; and
setting a black level to compensate pixel signal outputs of the semiconductor image sensor, the black level being determined from the measured temperature.

12. The method of claim 11, wherein the measuring act further comprises:
outputting a analog temperature-dependent signal from a temperature-sensitive element;
converting the temperature-dependent signal into a digital signal; and
transforming the digital signal into a temperature.

13. The method of claim 12, wherein the digital signal is transformed into a temperature using a linear relationship between the temperature and the digital signal.

14. The method of claim 11, wherein the setting a black level act further comprises:
calculating an amount of dark current that corresponds to the measured temperature; and
converting the amount of dark current to the black level.

15. The method of claim 14, wherein converting the amount of dark current comprises converting the amount of dark current to a charge value, and then converting the charge value to the black level.

16. The method of claim 11, wherein the measuring act comprises:
measuring a plurality of temperatures using a plurality of temperature-sensitive elements; and
averaging the plurality of temperatures to determine the temperature of the semiconductor image sensor.

17. The method of claim 11, wherein the measuring act comprises:
measuring a plurality of temperatures using a single temperature-sensitive element; and
averaging the plurality of temperatures to determine the temperature of the semiconductor image sensor.

18. The method of claim 11, further comprising using the measured temperature to calculate a color correction value to be applied to the pixel signal outputs of the semiconductor image sensor.

19. An imaging system, comprising:
an array of pixels for capturing an image;
a processing circuit for processing an image captured by the pixel array; and
a temperature compensation circuit, comprising:
a temperature-sensitive element configured to output a signal related to a sensed temperature of the array of pixels; and
a black level setting unit configured to use the signal output of the temperature-sensitive element to calculate a black level for the array of pixels.

20. The system of claim 19, wherein the black level setting unit comprises
a temperature-sensitive element output-to-temperature unit configured to convert the output signal of the temperature-sensitive element to a corresponding temperature; and
a temperature-to-black level unit configured to convert the temperature to the black level.

21. The system of claim 20, wherein the temperature-sensitive element output-to-temperature unit is configured to use a linear relationship between the signal output of the temperature-sensitive element and the corresponding temperature.

22. The system of claim 20, wherein the temperature-to-black level unit is configured to calculate a dark current value by using a relationship between the dark current value and a probability for exciting an electron from a top of a valence band to a bottom of a conductance band.

23. The system of claim 22, wherein the temperature-to-black level unit is configured to convert the dark current value to a charge value, and to convert the charge value to the black level.

24. The system of claim 19, wherein the temperature compensation circuit comprises a plurality of temperature-sensitive elements whose signal outputs are averaged for use by the black level setting unit.

25. The system of claim 19, wherein the black level setting unit is configured to input a time-averaged signal output of the temperature-sensitive element.

26. The system of claim 19, further comprising a color correction unit configured to use the signal output of the temperature-sensitive element to calculate a color correction value for a signal output of the array of pixels.

27. A processing system, comprising:
an array of pixels for capturing an image;
a temperature compensation circuit, comprising:
a temperature-sensitive element; and
a black level setting unit; and
a processing circuit configured to use the black level setting unit and a signal output of the temperature-sensitive element to calculate a black level for the array of pixels.

28. The system of claim 27, wherein the processing circuit is further configured to sample the signal output of the temperature-sensitive element a plurality of times over a set time period and determine an average signal output of the temperature-sensitive element.

29. The system of claim 27, wherein the temperature compensation circuit comprises a plurality of temperature-sensitive elements and the processing circuit is configured to calculate a black level by using an average signal output for all of the plurality of temperature-sensitive elements.

30. The system of claim 27, wherein the processing circuit is further configured to:
convert the signal output of the temperature-sensitive element to a corresponding temperature;
calculate a dark current value that corresponds to the temperature; and
transform the dark current value into the black level for the array of pixels.

31. The system of claim 30, wherein the processing circuit is configured to use a linear relationship to convert the signal output of the temperature-sensitive element to the corresponding temperature.

32. The system of claim 30, wherein the processing circuit is configured to calculate the dark current value by calculating a probability for exciting an electron from a top of a valence band to a bottom of a conductance band.

33. The system of claim 30, wherein the processing circuit is configured to transform the dark current value into a charge value, and then transform the charge value into the black level.

34. The system of claim 27, wherein the processing circuit is further configured to use the signal output of the temperature-sensitive element to calculate a color correction value for a signal output of the array of pixels.

35. The system of claim 27, wherein the processing circuit is further configured to use a lookup table to determine the black level that corresponds to the signal output of the temperature-sensitive element.

36. A digital camera, comprising:
an image sensor, comprising:
at least one pixel array;
a temperature-sensitive element positioned adjacent to the at least one pixel array; and
a black level setting unit; and
a processing circuit configured to use the black level setting unit and the signal output of the temperature-sensitive element to calculate a black level for the at least one pixel array.

37. The digital camera of claim 36, wherein the processing circuit is further configured to sample the signal output of the temperature-sensitive element a plurality of times over a set time period and determine an average signal output of the temperature-sensitive element.

38. The digital camera of claim 36, wherein the at least one imager comprises a plurality of temperature-sensitive elements and the processing circuit is configured to calculate a black level by using an average signal output for all of the plurality of temperature-sensitive elements.

39. The digital camera of claim 36, wherein the processing circuit is further configured to:
convert the signal output of the temperature-sensitive element to a corresponding temperature;
calculate a dark current value that corresponds to the temperature; and,
transform the dark current value into the black level for the at least one pixel array.

40. The digital camera of claim 36, wherein the processing circuit is further configured to use the signal output of the temperature-sensitive element to calculate a color correction value for a signal output of the at least one pixel array.

41. The digital camera of claim 36, wherein the processing circuit is further configured to use a lookup table to determine the black level that corresponds to the signal output of the temperature-sensitive element.

42. The digital camera of claim 36, wherein the camera is a still digital camera.

43. The digital camera of claim 36, wherein the camera is a video digital camera.

44. The digital camera of claim 36, wherein the camera is a cell-phone camera.

45. The digital camera of claim 36, wherein the camera is a handheld portable digital assistant (PDA) camera.
